(19) United States
(12) Patent Application Publication
(10) Pub. No.: US 2008/0049343 A1
(43) Pub. Date: Feb. 28, 2008

(54) Vehicle mirror assembly with reduced mirror shaking

(76) Inventor: Michael Dean Branham, Blythewood, SC (US)

Correspondence Address: MCNAIR LAW FIRM, P.A., P.O. BOX 10827, GREENVILLE, SC, 29603-0827, US

(21) Appl. No.: 11/507,742

(22) Filed: Aug. 22, 2006

(51) Int. Cl. G02B 7/182

(52) U.S. Cl. 359/877; 359/871

(57) ABSTRACT

A housing supporting a reflective mirrored element and having an internal support structure. A stationary mounting rod passing through the internal support structure and extending from the housing for attachment to a vehicle support arm. The housing and internal support structure rotate about the mounting rod. A stabilizing unit interconnecting the mounting rod and the internal support structure for resisting rotation of the housing around the mounting rod. The stabilizing unit includes a bushing fixed to the mounting rod engaging a bearing surface of the internal support structure in a sliding friction arrangement, and a clamping member biasing the bushing against the bearing surface to impart a clamping force between the bushing and the bearing surface, so that rotation of the internal support structure about the mounting rod is resisted to reduce mirror shaking caused by vibrations and loose connections between the mounting rod and the internal support structure.

### BACKGROUND OF THE INVENTION

1) Field of the Invention

The present invention relates to a vehicle mirror assembly, and more particularly, to a rotatably adjustable rear-view vehicle mirror with a stabilizing unit to reduce shaking of the mirror assembly.

2) Description of Related Art

Powered and manually rotatable rear-view mirrors for commercial vehicles, particularly commercial trucks, have been known in the art for many years. One well known embodiment of such a truck rear-view mirror is commonly referred to as a West Coast mirror and is preferably employed on trucks operating across North America.

An example of a West Coast mirror can be found in U.S. Pat. No. 5,760,980. The mirror assembly includes a mirror housing carrying an electric motor with a rotating gear, and a stationary longitudinal mounting rod extending through the mirror housing which is affixed to the vehicle. The motor gear cooperates with a secondary gear affixed to the longitudinal rod. As the motor turns, the gears cooperate to rotate the mirror housing around the stationary longitudinal rod. A problem with such mirrors arises with the motor, which typically has play between the gears that allows for slight uncontrolled rotation of the mirror assembly resulting primarily from wind and road vibrations. Shaking problems can result from play between the gears within the motor itself, and from play between the gears of the motor and the gear affixed to the stationary mounting rod that cause rotation about the rod. This gear play causes excessive shaking of the mirror that reduces the reflective characteristics the mirror is intended to provide.

Additionally, West Coast mirror designs such as the one discussed above, as well as other powered and manual rotatable mirror designs for large commercial vehicles, suffer from serious mirror shaking problems that result from wear and tear on the various supporting connections that cause these connections to loosen and lead to significant mirror shaking, as well as accelerating wear and tear on the mirror assemblies.

Another example of a powered vehicle mirror design can be found in U.S. Pat. No. 5,268,796 which discloses another complicated linkage arrangement with numerous moving parts and gear connections for rotating the mirror assembly around a stationary mounting rod. Such complicated rotating mechanisms are prone to loosening connections and gear play resulting in road and wind vibrations, which leads to excessive mirror shaking. The patent discusses a motor control mechanism for mirror positioning, but does not address the unique problems of gear play and loose connections that cause mirror shaking.

U.S. Pat. No. 4,787,726 discloses another powered vehicle mirror assembly with a plethora of gears for rotating the mirror around a stationary mounting rod. The gear arrangement acts as a slipper clutch to prevent damage to the motor and gears resulting from inadvertent rotation, such as from impact with an object. There is no disclosure for controlling the gear play that results from wear and tear on the mirror assembly and leads to mirror shaking.

Accordingly, it is an object of the present invention to provide a rotatable vehicle mirror assembly for a large commercial vehicle that has a stabilizing unit interconnecting the mirror housing and stationary mounting rod to reduce mirror shaking resulting from gear play and loose connections, and thereby improve reflected image quality in the mirror.

Additional objects and advantages of the invention will be set forth in part in the following description, or may be obvious from the description, or may be learned through practice of the invention.

### SUMMARY OF THE INVENTION

The above objective is accomplished according to the present invention by providing a vehicle mirror assembly constructed and arranged as detailed herein below and as illustrated in the figures. In one embodiment of the invention, the vehicle mirror assembly comprises a housing supporting a reflective mirrored element and defining an interior cavity. A carrier plate is disposed in the interior cavity of the housing for providing an internal support structure to carry the housing. A stationary mounting rod extends longitudinally through the carrier plate having a first end portion extending from a top of the housing and a second end portion extending from a bottom of the housing for mounting to a support arm adapted to attach to the vehicle. A motor is fixed to the carrier plate and operatively connected to the mounting rod for rotating the carrier plate and housing around the mounting rod to position the reflective mirrored element. A stabilizing unit is provided that interconnects the mounting rod and the carrier plate for resisting rotation of the carrier plate to reduce mirror shaking. The stabilizing unit includes a bushing carried by the rod in a fixed arrangement, a bearing recess carried by the carrier plate receiving the bushing in sliding engagement, and a clamping member carried by the carrier plate engaging the bushing to impart a clamping force biasing the bushing against the bearing recess. The clamping force maintains a sliding friction resistance between the bushing and the bearing recess to resist rotation of the carrier plate until a predetermined rotational force is exerted by the motor on the carrier plate so that mirror shaking resulting from loose gearing in the motor and other vibrations that tend to cause rotation of the mirror assembly are reduced.

In a further embodiment, the vehicle mirror assembly includes a concave bearing surface in the bearing recess complementary to a convex bearing surface of the bushing so that a uniform sliding engagement is provided between the bearing recess and the bushing. Preferably, the bearing recess receives approximately half of the circumference of the bushing for creating sliding friction between the bearing recess and the bushing.

In a further advantageous embodiment, the clamping member has a concave bearing surface complementary to a convex bearing surface of the bushing so that a uniform sliding engagement is provided between the clamping member and the bushing. Preferably, the clamping member receives approximately half of the circumference of the bushing for creating sliding friction between the clamping member and the bushing.

In a further embodiment, the mirror assembly includes a torque controller operatively associated with the clamping member for maintaining a predetermined minimum torque of the clamping member against the bushing to impart the clamping force. In this arrangement, the clamping member is slidably carried opposite the bearing recess and adjustably biased against the bushing for controlling the clamping force on the bushing.

In one embodiment, the clamping member includes a first end portion slidably carried on a first glide post, and a second end portion slidably carried on a second glide post; wherein a first securing member is carried at a distal end of the first glide post, and a second securing member is carried at a distal end of the second glide post to prevent the clamping member from sliding off of the first and second glide posts.

In a further preferred embodiment, compression springs are disposed around the first and second glide posts between the first and second securing members and the first and second end portions of the clamping member for maintaining a predetermined minimum torque of the clamping member against the bushing so that as wear and tear results from the sliding engagement between the bushing, the bearing recess and the clamping member, the clamping force is maintained by the compression springs. In a preferred embodiment, the predetermined minimum torque of the clamping member against the bushing is approximately 30 N·m. It is important to note, however, that as mirror dimensions and environmental factors change, the minimum torque of the clamping member against the bushing will need to be adjusted to increase or decrease the torque for the intended application to maintain a sufficient sliding friction resistance between the bushing and the bearing recess to resist rotation of the carrier plate as taught herein.

In a preferred embodiment, a first stabilizing unit is disposed proximate to the top of the housing in the interior cavity, and a second stabilizing unit is disposed proximate to the bottom of the housing in the interior cavity; wherein the first and second stabilizing units cooperate to impart a predetermined rotation restraint force to resist mirror shaking.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a perspective view of a mirror assembly mounted to a vehicle according to the present invention;

FIG. 2 shows a perspective view of the vehicle mirror assembly with a front portion of the housing removed to show the interior support structure and stabilizing units according to the present invention;

FIG. 3 shows an exploded view of the vehicle mirror assembly according to the present invention;

FIG. 4 shows a front elevation view of the vehicle mirror assembly according to the present invention;

FIG. 4a shows a cross-section view of a portion of the vehicle mirror assembly indicated in FIG. 4; and,

FIG. 5 shows a cross-section view of the bushing mounted in a fixed arrangement on the stationary mounting rod.

### DETAILED DESCRIPTION OF A PREFERRED EMBODIMENT

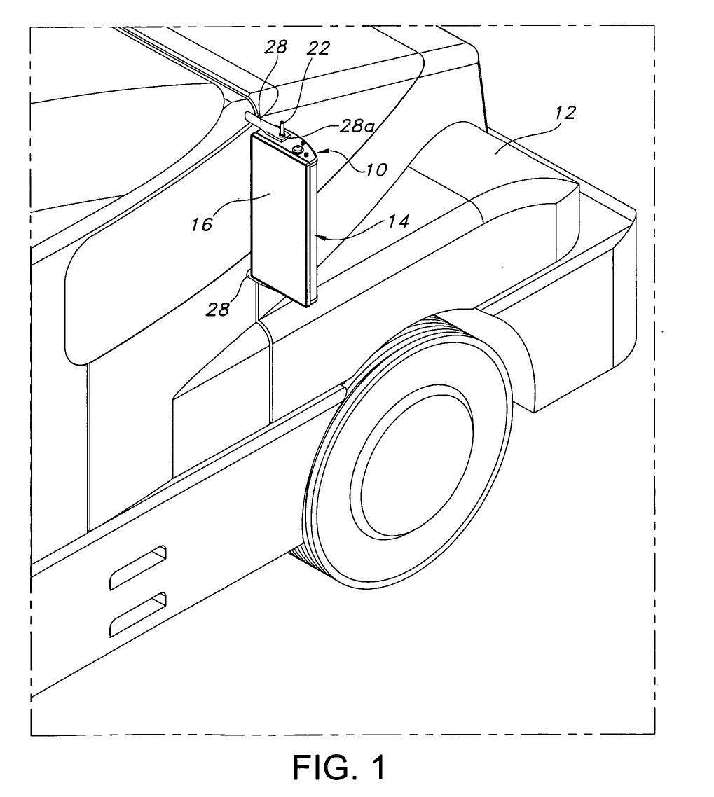

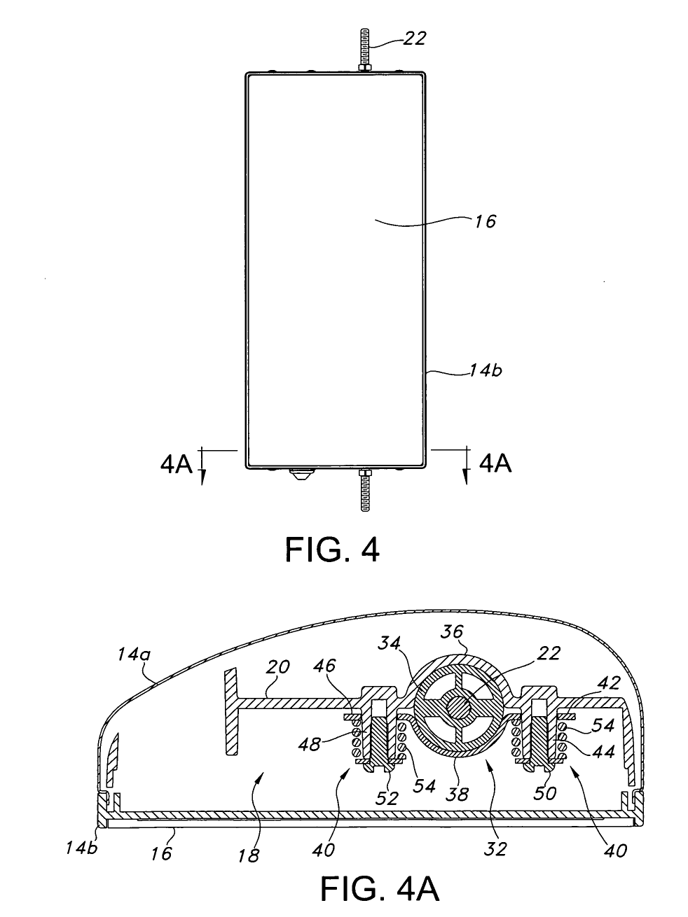

With reference to the drawings, the invention will now be described in more detail. Referring to FIG. 1, a vehicle mirror assembly, designated generally as 10, is shown mounted to a vehicle 12 illustrated as a large commercial vehicle, which is the primary intended application for the present invention. Vehicle mirror assembly 10 is shown with a housing, designated generally as 14, supporting a reflective mirrored element 16 positioned to allow a driver of vehicle 12 to view areas along the side of the vehicle. Referring to FIG. 4a, housing 14 includes a rear cover 14a, and a front cover 14b. When assembled together, rear and front covers 14a and 14b, respectively, define an interior cavity, designated generally as 18.

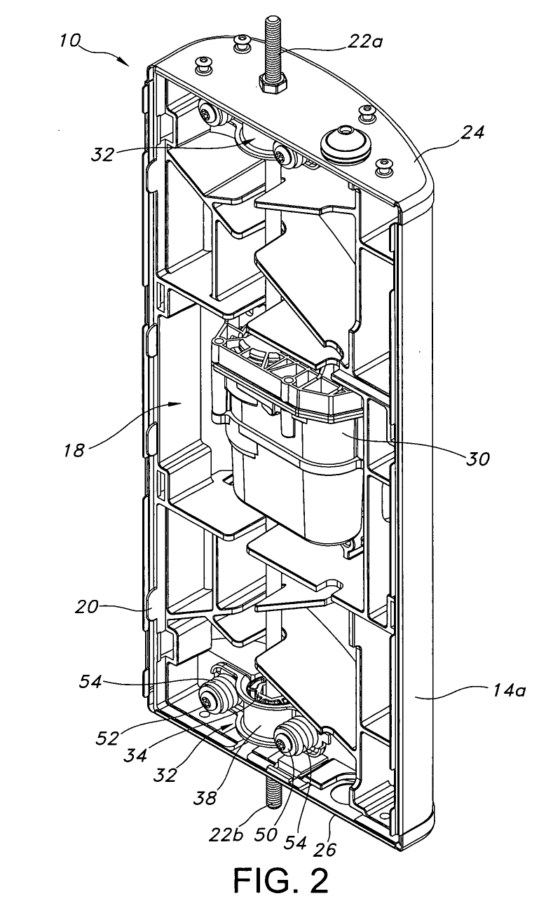

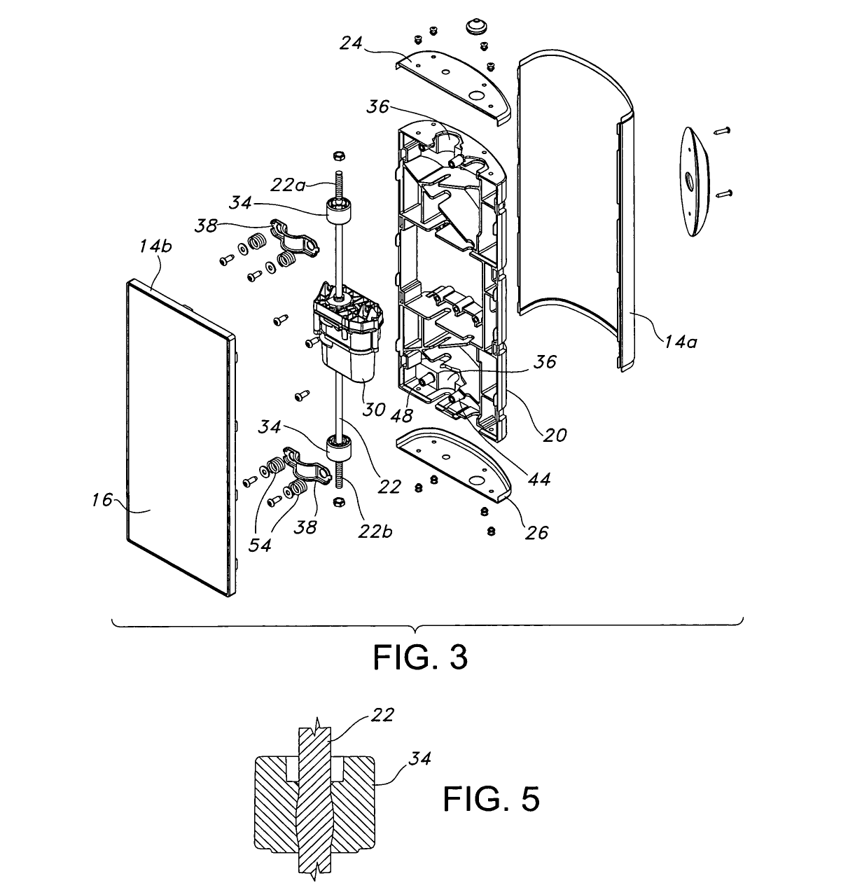

Referring to FIGS. 2 and 3, a carrier plate 20 is disposed in interior cavity 18 of housing 14 for providing an internal support structure to carry housing 14 and provide the necessary structural integrity and rigidity to support reflective mirrored element 16 on the exterior of vehicle 12. A stationary mounting rod 22 extends longitudinally through carrier plate 20. Carrier plate 20 is constructed and arranged to rotate about rod 22. Mounting rod 22 includes a first end portion 22a extending from a top cover 24 of housing 14, and a second end portion 22b extending from a bottom cover 26 of housing 14 for mounting to a support arm 28 (FIG. 1) adapted to attach to vehicle 12. As shown in FIG. 1, upper and lower support arms 28 are tubular members affixed to vehicle 12 that have a flattened end portion 28a receiving first and second end portion 22a and 22b in a fixed arrangement to prevent against rotation of stationary mounting rod 22 in flattened end portions 28a. This mounting arrangement is provided by way of example only, and other mounting components and arrangements known to those skilled in the art may be substituted without departing from the spirit and scope of the present invention.

Referring back to FIGS. 2 and 3, in a preferred embodiment, a motor 30 is fixed to carrier plate 20 and operatively connected to mounting rod 22. In this arrangement, housing 14 is carried by carrier plate 20, and carrier plate 20 is carried by motor 30, which is mounted to rod 22, so that carrier plate 20 and housing 14 rotate around stationary mounting rod 22 to position reflective mirrored element 16 as the driver desires. In an alternative embodiment, motor 30 may be eliminated to provide for manual rotation of housing 14 about stationary mounting rod 22. In either embodiment, the same concerns for mirror shaking resulting from wear and tear that creates loose connections, or from preexisting loose connections are present. In particular when using motor 30, however, is the fact that play between gears in motor 30 leads to shaking of the entire mirror assembly 10 when subject to typical road vibrations.

The present invention seeks to resist such mirror shaking by incorporating a stabilizing unit, designated generally as 32, interconnecting stationary mounting rod 22 and carrier plate 20 for resisting rotation of carrier plate 20 to reduce mirror shaking. Stabilizing unit 32 includes a bushing 34 carried by mounting rod 22 in a fixed arrangement so that there is no rotation between bushing 34 and mounting rod 22. As shown in FIG. 5, to help prevent rotation of bushing 34 on mounting rod 22, the rod is pressed to provide a bulge around which bushing 34 is friction fit or molded to hold bushing 34 in place. The bushing can also be attached by pins, adhesive or other well known means, as long as there is no free play between the bushing and the rod to eliminate any potential for vibration and shaking of the mirror assembly.

Stabilizing unit 32 further includes a bearing surface on carrier plate 20 that engages bushing 34 in a sliding friction arrangement that allows rotation of carrier plate 20 around bushing 34. With further reference to FIG. 4a, in a preferred embodiment, the bearing surface is provided in the form of a bearing recess 36 which receives bushing 34 in complementary fashion to maximize surface contact between bushing 34 and bearing recess 36 for increased friction. In the preferred embodiment, bearing recess 36 is molded as part of carrier plate 20, but may also be a bolt on or other supplemental component. In a preferred embodiment, bearing recess 36 includes a concave bearing surface complementary to a convex bearing surface of bushing 34 so that a uniform sliding engagement is provided between bearing recess 36 and bushing 34. As best shown in FIG. 4a, preferably, bearing recess 36 receives approximately half of the circumference of bushing 34 for creating sliding friction between the bearing recess and bushing 34, as well as helping to provide a stable arrangement for rotating carrier plate 20 around mounting rod 22. Although the illustrated embodiment shows bushing 34 and bearing recess 36 as being cylindrical in form, they may alternatively be constructed in a spherical, conical or other shape that allows for revolution and rotation between these components.

Stabilizing unit 32 also includes a clamping member 38 carried by carrier plate 20 that engages bushing 34 to impart a clamping force biasing bushing 34 into and against bearing recess 36, as well as against clamping member 38. The clamping force provides and maintains a sliding friction resistance between bushing 34 and bearing recess 36, and between bushing 34 and clamping member 38, to resist rotation of carrier plate 20 until a predetermined rotational force is exerted by motor 30, or by hand, on carrier plate 20. In this arrangement, mirror shaking resulting from loose gearing in motor 30, or other loose connections resulting from wear and tear, and other vibrations that tend to cause rotation of the mirror assembly is reduced due to the sliding friction resistance. As with bearing recess 36, clamping member 38 has a concave bearing surface complementary to a convex bearing surface of bushing 34 so that a uniform sliding engagement is provided between clamping member 38 and bushing 34. Preferably, clamping member 38 receives approximately half of the circumference of bushing 34 for creating sliding friction between the clamping member and bushing 34, as well as further helping to stabilize and support the interconnection between the carrier plate 20 and mounting rod 22.

Preferably, a pair of stabilizing units 32 are provided for controlling mirror shaking. A first stabilizing unit is disposed proximate to top cover 24 of housing 14 in interior cavity 18, and a second stabilizing unit is disposed proximate to bottom cover 26 of housing 14 in interior cavity 18. Both stabilizing units cooperate to impart a predetermined rotation restraint force to resist mirror shaking. Alternatively, there could also be more than two stabilizing units, and the stabilizing units may be located at any position within the mirror housing.

Referring to FIG. 4a, a torque controller, designated generally as 40, is provided in a controlling arrangement with clamping member 38 for maintaining a predetermined minimum torque of clamping member 38 against bushing 34 to impart and maintain the desired clamping force necessary to establish a sufficient sliding friction restraint between bushing 34 and bearing recess 36. In the illustrated embodiment, clamping member 38 includes a first end portion 42 slidably carried on a first glide post 44 for allowing adjustment of clamping member 38 against bushing 34. A second end portion 46 is also slidably carried on a second glide post 48 for allowing adjustment of clamping member 38 against bushing 34.

To control the adjustable sliding arrangement of clamping member 38 against bushing 34, torque controller 40 includes a first securing member 50, in the form of a screw and washer, carried at a distal end of first glide post 44. Further, a second securing member 52, also in the form of a screw and washer, is carried at a distal end of second glide post 48 to prevent clamping member 38 from sliding off of first and second glide posts 44 and 48. Compression springs 54 are disposed around first and second glide posts 44 and 48 between first and second securing members 50 and 52 and first and second end portions 42 and 46 of clamping member 38 for maintaining a predetermined minimum torque of clamping member 38 against bushing 34 so that as wear and tear results from the sliding engagement between bushing 34, bearing recess 36 and clamping member 38, the clamping force is maintained by the compression springs. Preferably, the predetermined minimum torque of clamping member 38 against bushing 34 maintained by compression springs 54 is approximately 30 N·m.

In an alternative arrangement, instead of compression springs, a clamp could also be used that uses the elastic deformation of the clamp to bias against the bushing, which acts in the same manner as compression springs 54. Further, each stabilizing unit could alternatively use only one spring, but the force is more evenly distributed using dual compressing springs as detailed above.

While a preferred embodiment of the invention has been described using specific terms, such description is for illustrative purposes only, and it is to be understood that changes and variations may be made without departing from the spirit or scope of the following claims.

1. A vehicle mirror assembly having reduced mirror shaking comprising:
a housing supporting a reflective mirrored element and defining an interior cavity;
a carrier plate disposed in said interior cavity of said housing for providing an internal support structure carrying said housing;
a stationary mounting rod extending longitudinally through said carrier plate having a first end portion extending up from a top of said housing and a second end portion extending down from a bottom of said housing. wherein said first end portion is affixed to an upper support arm and said second end portion is affixed to a lower support arm for mounting to a vehicle;
a motor fixed to said carrier plate and operatively connected to said mounting rod so that said carrier plate and housing are rotated by said motor around said mounting rod to position said reflective mirrored element; and,
a stabilizing unit interconnecting said mounting rod and said carrier plate for resisting rotation of said carrier plate to reduce mirror shaking; said stabilizing unit including:
a bushing carried by said rod in a fixed arrangement;
a bearing recess carried by said carrier plate receiving said bushing in sliding engagement; and,
a clamping member carried by said carrier plate engaging said bushing to impart a clamping force biasing said bushing against said bearing recess;
whereby said clamping force maintains a sliding friction resistance between said bushing and said bearing recess to resist rotation of said carrier plate until a predetermined rotational force is exerted by said motor on said carrier plate so that mirror shaking resulting from loose gearing in said motor is reduced.

2. The vehicle mirror assembly of claim 1 including a concave bearing surface in said bearing recess complementary to a convex bearing surface of said bushing so that a uniform sliding engagement is provided between said bearing recess and said bushing.

3. The vehicle mirror assembly of claim 2 wherein said bearing recess receives approximately half of the circumference of said bushing for creating sliding friction between said bearing recess and said bushing.

4. The vehicle mirror assembly of claim 1 wherein said clamping member has a concave bearing surface complementary to a convex bearing surface of said bushing so that a uniform sliding engagement is provided between said clamping member and said bushing.

5. The vehicle mirror assembly of claim 4 wherein said clamping member receives approximately half of the circumference of said bushing for creating sliding friction between said clamping member and said bushing.

6. The vehicle mirror assembly of claim 1 wherein said clamping member is slidably carried opposite said bearing recess and adjustably biased against said bushing for controlling said clamping force on said bushing.

7. The vehicle mirror assembly of claim 6 wherein said clamping member includes a first end portion slidably carried on a first glide post, and a second end portion slidably carried on a second glide post; wherein a first securing member is carried at a distal end of said first glide post, and a second securing member is carried at a distal end of said second glide post to prevent said clamping member from sliding off of said first and second glide posts.

8. The vehicle mirror assembly of claim 7 including compression springs disposed around said first and second glide posts between said first and second securing members and said first and second end portions of said clamping member for maintaining a predetermined minimum torque of said clamping member against said bushing so that as wear and tear results from the sliding engagement between said bushing, said bearing recess and said clamping member, said clamping force is maintained by said compression springs.

9. The vehicle mirror assembly of claim 8 wherein said predetermined minimum torque of said clamping member against said bushing is approximately 30 N·m.

10. The vehicle mirror assembly of claim 1 including a first stabilizing unit disposed proximate to said top of said housing in said interior cavity, and a second stabilizing unit disposed proximate to said bottom of said housing in said interior cavity; wherein said first and second stabilizing units cooperate to impart a predetermined rotation restraint force to resist mirror shaking.

11-25. (canceled)
